(19) United States
(12) Patent Application Publication
(10) Pub. No.: US 2022/0117174 A1
(43) Pub. Date: Apr. 21, 2022

(54) SELF-WATERING PLANTER

(71) Applicant: C3 Gardens, LLC, Naples, FL (US)

(72) Inventor: Jack Barnwell, Naples, FL (US)

(73) Assignee: C3 Gardens, LLC, Naples, FL (US)

(21) Appl. No.: 17/422,371

(22) PCT Filed: Feb. 13, 2020
(86) PCT No.: PCT/US20/18097

§ 371 Date: Jul. 12, 2021

Related U.S. Application Data
(60) Provisional application No. 62/806,380, filed on Feb. 15, 2019.

(51) Int. Cl. A01G 27/02; A01G 27/00

(52) U.S. Cl. CPC A01G 27/02; A01G 27/008

(57) ABSTRACT

A self-watering planter, and a method for watering a plant, are described. A self-watering planter may include a container defining a cavity, a platform in the container that separates the cavity into two environments, and a fill tube and a down tube extending through the platform.

### CROSS-REFERENCE TO RELATED APPLICATIONS

This application claims priority to U.S. Provisional Application No. 62/806,380, filed under 35 U.S.C. § 111(b) on Feb. 15, 2019, the entire disclosure of which is incorporated herein by reference for all purposes.

### BACKGROUND

Current self-watering planters are prone to problems or otherwise have disadvantages such as poor root growth from improper watering, inefficient water and nutrient delivery, toxic mineral buildup, fungi, and the use of cheap plastics. Thus, there is a need for new and improved self-watering planters.

### SUMMARY

Provided herein is a self-watering planter comprising a container comprising a bottom wall and at least one side wall which defines a cavity in the container, wherein the at least one side wall includes a hole therethrough; a platform having a first surface and a second surface and an outer wall, wherein the platform is adapted to fit in the cavity and thereby separate the cavity into a first environment and a second environment, wherein the platform has an aperture extending through the platform and an opening extending through the platform, and wherein the aperture includes a down tube retaining feature; a down tube having a body spanning a length between a first end and a second end, wherein the first end includes a platform retaining feature configured to mate with the down tube retaining feature, wherein the down tube further comprises at least one slit along the length of the body; and a fill tube having a body extending between a fill tube first end and a fill tube second end, wherein the fill tube is configured to extend through the opening in the platform.

Further provided herein is a self-watering planter comprising a container defining a cavity between an open top and a closed bottom, wherein the container comprises a side wall extending from the open top to the closed bottom; a rim extending around a perimeter of the container in the cavity; a platform configured to rest on the rim in the container, wherein the platform comprises an aperture extending therethrough with a down tube retaining feature, and an opening extending therethrough; a down tube comprising a platform retaining feature configured to mate with the down tube retaining feature of the aperture; and a fill tube configured to extend through the opening. In certain embodiments, the down tube comprises at least one slit therethrough. In certain embodiments, the self-watering planter further comprises a drainage hole in the side wall. In particular embodiments, the drainage hole is positioned between the rim and the closed bottom of the container. In certain embodiments, the container comprises ceramic.

Further provided is a self-watering planter comprising a container defining a cavity between an open top and a closed bottom, wherein the container comprises a side wall extending from the open top to the closed bottom; and a single molded piece defining a platform and a down tube, a single molded piece defining a platform and a down tube, wherein the platform is configured to rest on a rim in the container and the down tube is configured to extend from the platform, wherein the downtube includes at least one slit configured to allow passage of a liquid through the down tube.

Further provided is a self-watering planter comprising a container defining a cavity between an open top and a closed bottom, wherein the container comprises a side wall extending from the open top to the closed bottom; a rim extending around a perimeter of the container in the cavity; a platform configured to rest on the rim in the container and thereby divide the cavity into a first environment and a second environment; and a down tube configured to extend from the aperture to the first environment.

Further provided is a self-watering planter comprising a container defining a cavity between an open top and a closed bottom, wherein the container comprises a side wall extending from the open top to the closed bottom, wherein the side wall includes a hole therethrough; a platform adapted to fit in the cavity and thereby separate the cavity into a first environment and a second environment, wherein the platform has an aperture extending through the platform and having a down tube retaining feature; and a down tube having a body spanning a length between a first end and a second end, wherein the first end includes a platform retaining feature configured to mate with the down tube retaining feature, wherein the down tube further comprises at least one slit along the length of the body configured to allow passage of a liquid therethrough.

Further provided is a self-watering planter comprising a removable platform resting on an annular rim within a container, wherein the platform divides the container into a first environment and a second environment; and a down tube attached to the platform and extending from the platform into the first environment, wherein the downtube includes at least one slit configured to allow passage of a liquid therethrough.

Further provided herein is a self-watering planter comprising a container having a first environment configured to house water and a second environment configured to house soil, wherein liquid can pass from the first environment to the second environment through a down tube having at least one slit therein.

Further provided is a self-watering planter comprising a container having a first environment configured to house water and a second environment configured to house soil, wherein liquid can pass from the first environment to the second environment through a down tube having at least one slit therein.

Further provided is a self-watering planter comprising a container configured to store liquid in a first environment and house a plant planted in soil in a second environment; and a platform and downtube assembly configured to separate the first environment from the second environment and allow passage of the liquid therebetween.

Further provided herein is a method of watering a plant, the method comprising mating a down tube with a platform to form an assembly, wherein the down tube includes at least one slit therethrough; inserting the assembly into a container; adding soil to the assembly; planting a plant in the soil; and watering the plant by housing water in the container so as to travel through the slit.

Various aspects of this invention will become apparent to those skilled in the art from the following detailed description of the preferred embodiment, when read in light of the accompanying drawings.

### BRIEF DESCRIPTION OF THE DRAWINGS

The patent or application file may contain one or more drawings executed in color and/or one or more photographs. Copies of this patent or patent application publication with color drawing(s) and/or photograph(s) will be provided by the U.S. Patent and Trademark Office upon request and payment of the necessary fees.

FIG. 1 is a perspective view of an embodiment of a self-watering planter in accordance with the present disclosure.

FIG. 2 is a perspective view of a container employed in the self-watering planter illustrated in FIG. 1.

FIG. 3A is a photograph showing an embodiment of a container for a self-watering planter that includes a platform engagement surface (a rim) protruding from a side wall and encircling the cavity in the container. FIG. 3B is a photograph showing an embodiment of the container including a platform engagement surface protruding from a side wall, where a hand is pointing at the platform engagement surface.

FIG. 4 is a bottom plan view of an embodiment of a platform for a self-watering planter in accordance with the present disclosure.

FIG. 5 is a photograph showing a perspective view of an embodiment of a platform for a self-watering planter, where a sealing member is attached to the platform.

FIG. 6 is a side elevational view of an embodiment of a down tube for a self-watering planter.

FIG. 7 is a photograph showing a perspective view of the platform having an attached sealing member from FIG. 5, as well as a portion of a down tube as illustrated in FIG. 6.

FIG. 8 is a perspective view of a down tube attached to a platform, and a fill tube in isolation.

FIG. 9 is a photograph showing a perspective view of the platform with an attached sealing member and attached down tube as seen in FIG. 7 inserted into a container of a self-watering planter.

FIG. 10 is a perspective view of a platform with a down tube attached to the platform and further including a fill tube extending through an opening in the platform.

FIG. 11 is a photograph showing a perspective view of an assembly having the platform with the down tube attached to the platform and the fill tube extending through the opening in the platform as shown in FIG. 10 and further including a sealing member attached to the platform and sleeve attached to the fill tube. The assembly is shown outside of a container.

FIG. 12 is a photograph showing a perspective view of a platform with a sealing member attached to the platform and the fill tube extending through the platform with the fill tube including a sleeve that engages the platform.

FIG. 13 is a photograph showing a top-down view of a self-watering planter, where the platform is supported by, and rests on, a platform engagement surface in the container without a sealing member.

FIG. 14 is a perspective view of the self-watering planter from FIG. 1 further including the presence of water in a first environment inside the container and the presence of soil in a second environment inside the container.

### DETAILED DESCRIPTION

The present disclosure relates to an improved self-watering planter and a method of assembling a self-watering planter.

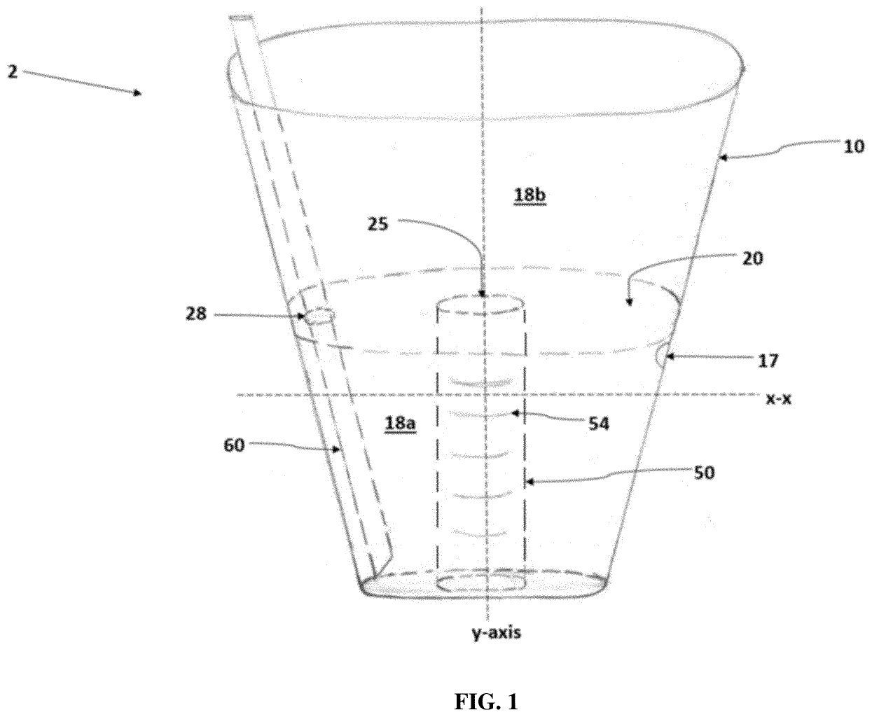

Referring now to the drawings, there is illustrated in FIG. 1 an embodiment of a self-watering planter 2. The self-watering planter 2 may include a container 10, a platform 20, a down tube 50 (which may also be referred to a soil tube), a fill tube 60, and, optionally, a sealing member 40. As will be described below, the self-watering planter 2 can be easily assembled by a person without the use of any tools or glue.

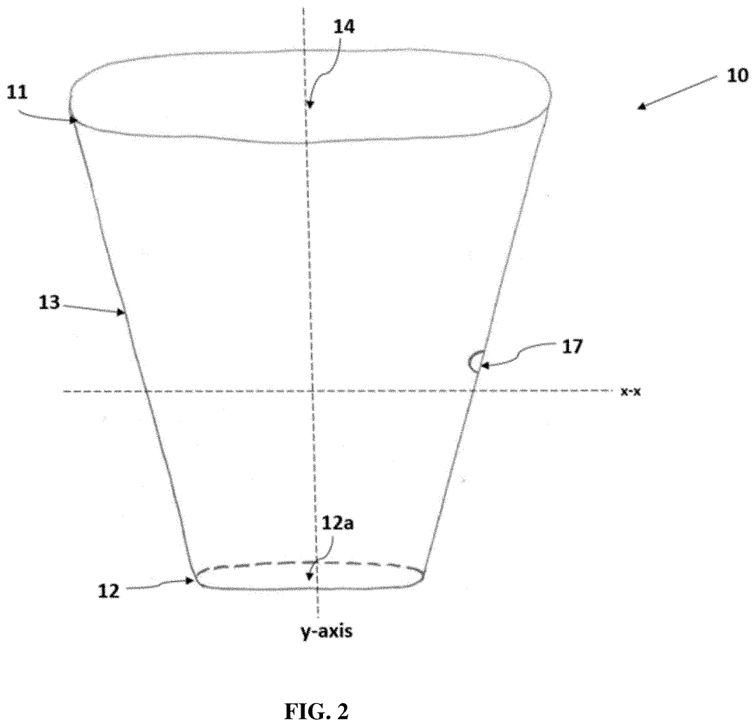

Referring to FIG. 2, the self-watering planter 2 may include a container 10 that functions to hold water, growing medium (i.e., soil), and plants. In some embodiments, the container 10 may be a pot. The container 10 may have a top 11, a bottom 12, and at least one side wall 13 that extends between the top 11 and the bottom 12. The top 11 may include an orifice 14 and the bottom 12 may include a bottom wall 12a. The side wall 13 may be tapered. The bottom wall 12a and the side wall 13 together define a cavity 16 in the container 10 which is accessible via the orifice 14 at the top 11 of the container 10.

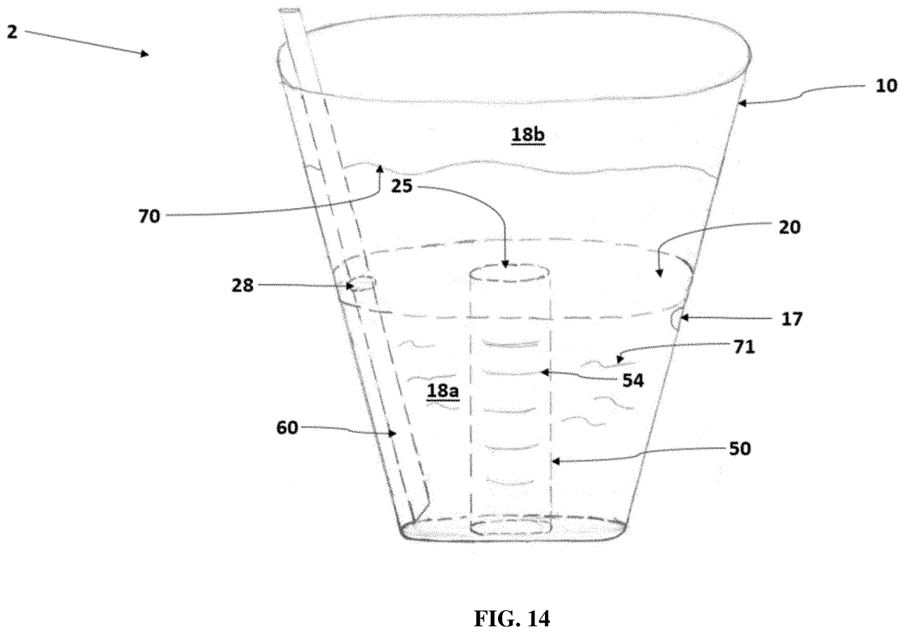

The container 10 may have an open top 11 and a closed bottom 12. A container 10 having a closed bottom 12 offers numerous advantages over conventional containers. Conventional containers feature a drainage hole in the bottom of the container which allows vital plant nutrients to leech through the soil and be washed from the container during watering. These nutrients can also stain surfaces such as pool decks or patios, which is not desirable. The container 10 having a closed bottom 12, on the other hand, beneficially retains water and nutrients in the cavity 16, as shown in FIG. 14, while preventing damage and staining to the surrounding environment through undesirable leaching.

In the embodiment illustrated in FIGS. 1-2, the container 10 extends axially about a y-axis which passes through the center of the container 10 from the bottom 12 to the top 11. The container 10 has a circular cross-section, taken along line x-x, but in other embodiments the container 10 may have a cross-section of another shape such as rectangular, triangular, or elliptical. The container 10 may include side walls 13 that taper radially inward along the y-axis from the top 11 of the container 10 to the bottom 12 of the container 10. However, in other embodiments, the side walls 13 may taper radially outward along the y-axis from the top 11 of the container 10 to the bottom 12 of the container 10 or, alternatively, may not taper at all.

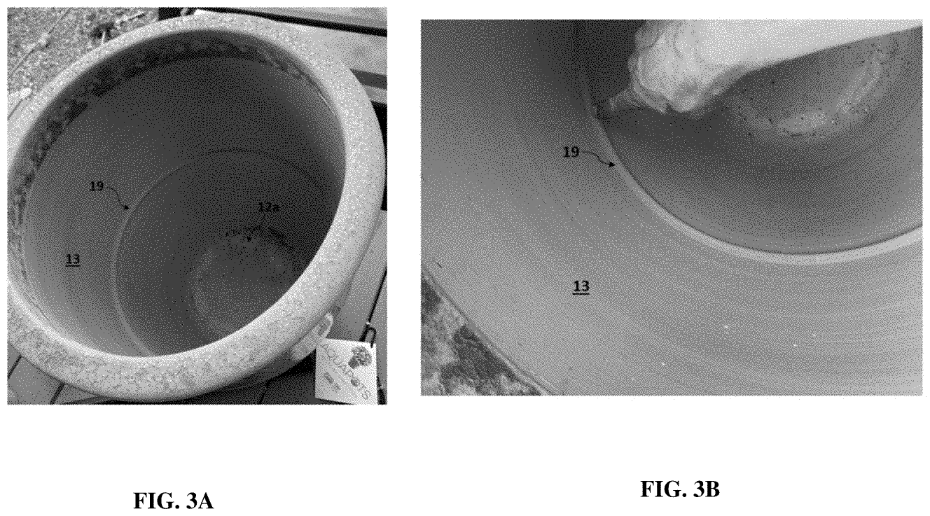

Referring now to FIGS. 3A-3B, the side wall 13 may include a platform engagement surface 19. The platform engagement surface 19 may be formed from an inner surface of the side wall 13 projecting radially inward toward the y-axis. The platform engaging surface 19 may be produced using with the mold for the container 10, and therefore may be of the same material as the container 10. The platform engagement surface 19 may act as a rim on which the platform 20 sits. The platform engagement surface 19 may encircle the cavity 16. The platform engagement surface 19 together with the platform 20 may form a tight seal without the need for additional material or sealants. The platform engagement surface 19 also allows for the platform 20 to be easily removed from the self-watering planter 2 for easy cleaning, because the platform 20 does not need to be adhered to the platform engagement surface 19 in order to form a tight seal.

As best illustrated in FIGS. 1-2, the container 10 may include a hole 17 through the side wall 13. However, in other embodiments, the container 10 may include more than one hole 17 through the side wall 13 or side walls. The hole 17 may function as a drain to remove excess water from the container 10 to prevent overfilling the container 10 with water. The location of the hole 17 in relation to the bottom wall 12a determines the amount of water the container 10 can store at a time. In some embodiments, the hole 17 is below the platform engagement surface 19 in the side wall 13. In other words, the hole 17 may be positioned between the bottom wall 12a and the platform engagement surface 19. In such embodiments, the hole 17 may be substantially nearer the platform engagement surface 19 than the bottom wall 12a.

The container 10 can be made of a variety of materials, including but not limited to stoneware glazed ceramics. The use of a ceramic container 10 provides advantages in appearance and durability over conventional self-watering planters that include plastic containers. For example, a ceramic container 10 can be recycled, unlike plastic containers. At the end of its life, the ceramic can be ground up and composted, turned into soil, or made into a gravel mix. The container 10 can be any suitable size and shape. For example, in the embodiment shown in FIGS. 1-2, the container 10 has a tapered side wall 13 that defines a cavity 16 having a circular cross-section. However, the container 10 can have a plurality of side walls 13 which may or may not taper and which define a cavity 16 having a cross-section of various shapes, such as rectangular, elliptical, or triangular. As seen in FIGS. 1-2, the circular cross-section of the container 10 may taper with the side walls 13.

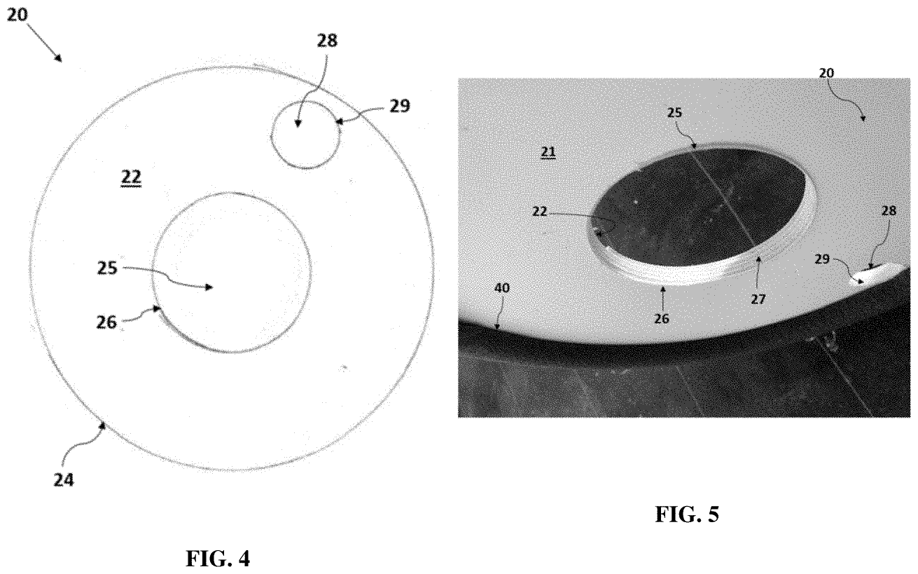

Referring now to FIGS. 1, 4, 5, the self-watering planter 2 may further include a platform 20. The platform 20 may also be referred to as a disk. However, it is understood that the platform need not be circular in shape. Rather, the platform 20 may take any suitable shape so as to fit within the container 10. The platform 20 can be made of a variety of materials such as, but not limited to, plastic. As best shown in FIGS. 4-5, and 8, the platform 20 may have a first surface 21 and a second surface 22 with a body 23 having a thickness that extends between the first surface 21 and the second surface 22. The platform 20 may have an outer wall 24 that extends around the perimeter of the platform 20. Advantageously, if the container 10 is accidentally broken, the platform 20 can be reused in a different container 10 to form a new self-watering planter 2.

Referring still to FIGS. 4-5, the platform 20 may further include an aperture 25. The aperture 25 may extend through the platform 20 from the first surface 21 to the second surface 22. The aperture 25 is defined by aperture walls 26 which are part of the platform 20. The size and shape of the aperture 25 can vary. In the embodiment depicted in FIGS. 4-5, the aperture walls 26 define an aperture 25 having a circular shape. The aperture 25 can be located anywhere on the platform 20. However, it is beneficial to place the aperture 25 near the center of the platform 20, as will be explained below.

Referring now to FIGS. 5-7, the platform 20 may include a down tube retaining feature 27 to releasably attach the down tube 50 to the platform 20. The down tube retaining feature 27 can take a variety of forms such as a threaded surface, a snap fit, or other releasable attachment mechanism. As best illustrated in FIGS. 5 and 7, the down tube retaining feature 27 may comprise a threaded surface located on the aperture walls 26 which is configured to mate with a threaded surface of the down tube 50, as will be explained below. The threaded surface of the down tube retaining feature 27 can be made, for example, with a tap and die set. However, the down tube retaining feature 27 is not limited to being a threaded surface, and may be, for example, a snap fit, or other releasable attachment mechanism. Many other down tube retaining features 27 are possible and encompassed within the scope of the present disclosure.

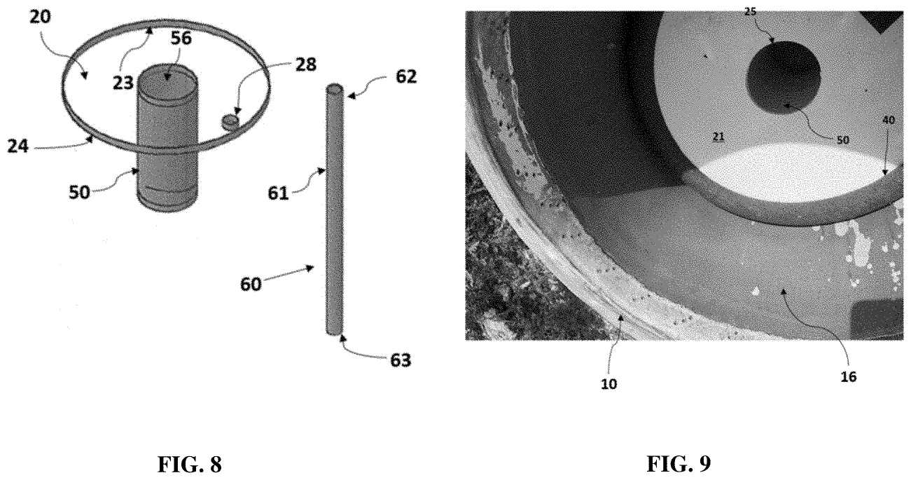

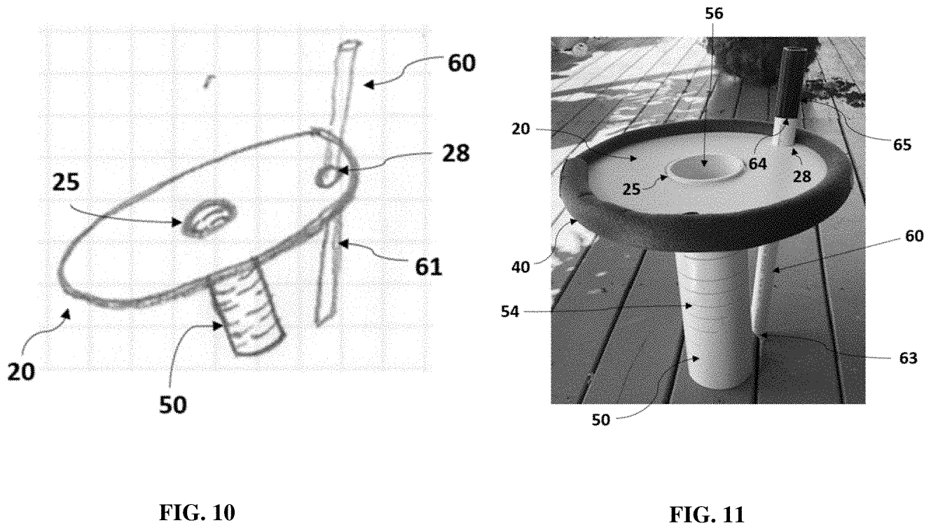

Referring now to FIGS. 2, 8, 10-11, the platform 20 may further include an opening 28. The opening 28 may extend through the platform 20 from the first surface 21 to the second surface 22. The opening 28 is defined by opening walls 29 which are part of the platform 20. The size and shape of the opening 28 can vary. For example, in the embodiment depicted in FIGS. 2 and 8, the opening 28 is offset from the outer wall 24 that extends around the perimeter of the platform 20. In this case, the opening 28 is completely bounded by the body 23 of the platform 20, as shown in FIGS. 4 and 10. In the alternative, the opening 28 can be located at the outer wall 24 that extends around the perimeter of the platform 20. In this case, the opening 28 is only partially bounded by the body 23 of the platform 20. In either case, the opening 28 is configured to receive the fill tube 60.

The platform 20 may optionally include a fill tube retaining feature to releasably attach the fill tube 60 to the platform 20. The optional fill tube retaining feature can take a variety of forms including, but not limited to, a form fit, a threaded surface, a snap fit, or other releasable attachment mechanism.

The platform 20 may have a size and shape configured to match the cross-section of the container 10 as defined by the side walls 13. In the embodiment illustrated in FIGS. 1, 9, and 13, the platform 20 is disk-shaped to match the circular cross-section of the container 10. As will be explained below, the platform 20 may be inserted into the cavity 16 in the container 10. The outer walls 24 of the platform 20 may engage the inner surface of the side walls 13 of the container 10 to stabilize the platform 20 in the cavity 16 and to divide the container 10 into a first environment 18a and a second environment 18b. In some embodiments, the second surface 22 of the platform 20 may cooperate with the platform engagement surface 19 of the side wall 13 to support the platform in the cavity 16. The platform 20 may thus be sized to fit snugly within the container 10 to form a tight seal without the need for additional materials or sealants.

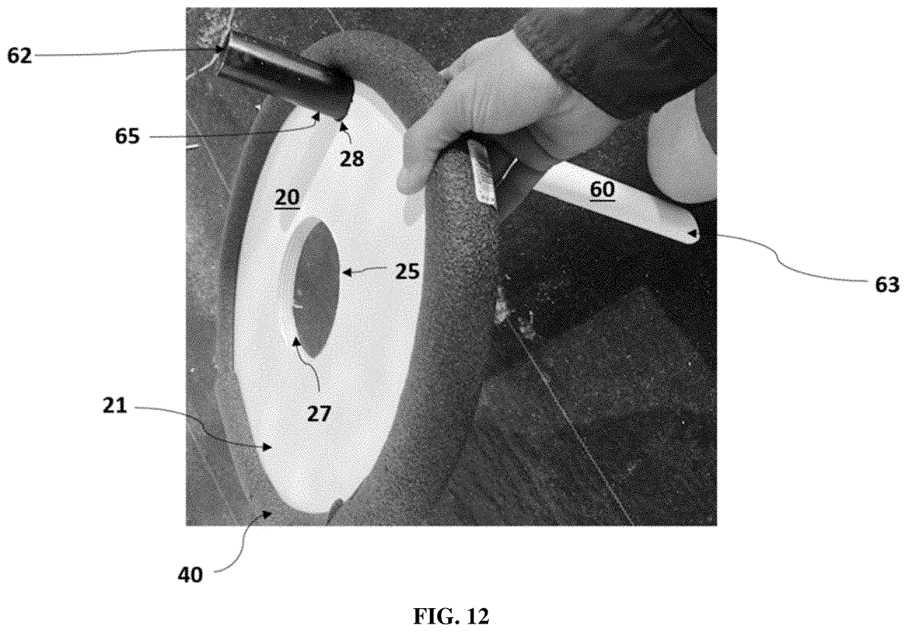

Referring now to FIGS. 9, 11-12, the self-watering planter 2 may optionally further include a sealing member 40. As noted above, the sealing member 40 is not necessary when the container 10 includes a platform engagement surface 19. Thus, the sealing member 40 is an optional component of the self-watering planter 2. In any event, the sealing member 40 can be an insulating foam or some other deformable material. As best illustrated in FIGS. 11-12, the sealing member 40 may be attached to the platform 20 at the outer wall 24 so that the sealing member 40 extends around the perimeter of the platform 20. However, in some embodiments, the sealing member 40 may not completely extend around the perimeter of the platform 20.

The sealing member 40, if included, may provide several benefits to the self-watering planter 2. First, the sealing member 40 may help stabilize the platform 20 in the cavity 16 in the container 10. Even containers of the same size can have slightly different dimensions resulting from the manufacturing process. The sealing member 40 can account for slight deviations between containers 10 by providing a deformable material that can be compressed between the side wall 13 of the container 10 and the outer wall 24 of the platform 20 to form a snug fit between the container 10 and the platform 20, as shown in FIG. 9. Second, the sealing member 40 may form a seal between the platform 20 and the container 10 to form a physical barrier that separates the container 10 into a first environment 18a, which may act as a water reservoir, and a second environment 18b, which may contain plant material and a growing medium, such as soil.

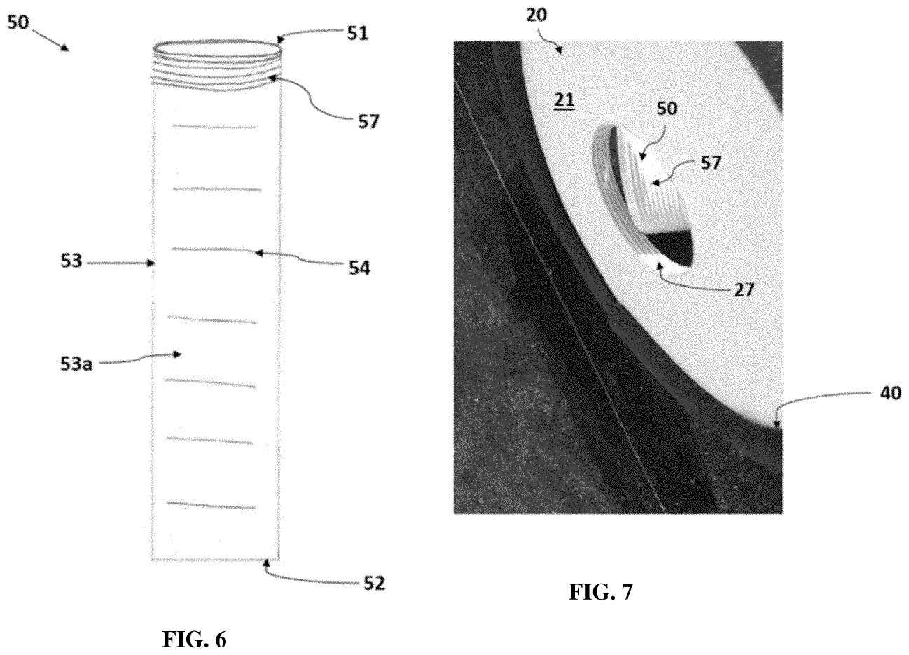

Referring now to FIGS. 1, 6, 8, 11, the self-watering planter 2 may further include a down tube 50. The down tube 50, which may also be called a soil tube, can be made of a variety of materials, such as, but not limited to, PVC pipe. As best shown in FIGS. 6 and 11, the down tube 50 may have a first end 51 and a second end 52 with a down tube body 53 spanning a linear length between the first end 51 and the second end 52. The down tube 50 may have a cylindrical body 53 with a body wall 53a defining a space 56 in the down tube 50, as shown in FIGS. 8 and 11. As will be explained below, the first end 51 of the down tube 50 can engage the platform 20 and the second end 52 of the down tube 50 can engage the bottom wall 12a of the container 10. When in place, the down tube 50 may be filled with soil in which a plant's roots may grow and wick up water from the first environment 18a.

Though the down tube 50 is depicted in FIGS. 1, 6, 8, 10, 11 as being tubular in shape, the down tube may have a variety of shapes. For example, the down tube 50 may have a cone shape. Advantageously, a cone shape provides the benefit of being able to nest multiple down tubes 50 together for more efficient packaging and shipping.

Referring now to FIG. 7, the down tube 50 may include a platform retaining feature 57 to releasably attach the down tube 50 to the platform 20. The platform retaining feature 57 can take a variety of forms such as a threaded surface, a snap fit, or other releasable attachment mechanism. However, other platform retaining features 57 are possible and encompassed within the scope of the present disclosure. The platform retaining feature 57 is configured to cooperate with the down tube retaining feature 27 to releasably attach the down tube 50 to the platform 20. In the embodiment depicted in FIG. 7, the platform retaining feature 57 comprises a threaded surface located at the first end 51 which is configured to mate with the threaded surface of the down tube retaining feature 27 located on the aperture walls 26. As shown in FIG. 7, the down tube 50 is externally threaded as the threaded surface is located on the outer surface of the body 53 and the platform 20 is internally threaded as the threaded surface is located on the aperture walls 26 within the perimeter of the of platform 20. The threaded surface of the platform retaining feature 57 and the threaded surface of the down tube retaining feature 27 can be made, for example, using a tap and die set. A user can releasably attach the down tube 50 to the platform 20 by manually twisting the first end 51 of the down tube 50 into the aperture 25 in the platform 20.

The down tube retaining feature 27 and the platform retaining feature 57 provide many advantages. First, the retaining features 27 and 57 allow a user to attach the down tube 50 to the platform 20 without tools or glue. Thus, a user does not need to worry about having the right tools to attach the down tube 50 to the platform 20. Moreover, the user does not need to deal with the hassle of glue, such as waiting for the glue to set and hoping that when the glue sets the platform 20 is still properly oriented relative to the down tube 50. Second, the retaining features 27 and 57 allow the down tube 50 to be easily detached from the platform 20 without causing damage to the down tube 50 or the platform 20. If the down tube 50 is glued to the platform 20, it may be impossible to remove the down tube 50 from the platform 20 without causing irreversible damage to the down tube 50 and/or the platform 20 so that the down tube 50 and platform 20 cannot be reused. The present disclosure ensures that the down tube 50 can be reattached to the platform 20, which reduces waste because the down tube 50 and the platform 20 can be reused in the self-watering planter 2. Moreover, the simplicity with which the retaining features 27 and 57 can be disengaged, such as by unscrewing the down tube 50 from the platform 20, make cleaning the self-watering planter 2 simple. The down tube 50 is detached from the platform 20, such as by unscrewing the down tube 50 from the platform 20, and both the down tube 50 and the platform 20 can be removed from the container 10 allowing the interior of the container 10 to be cleaned. Third, the retaining features 27 and 57 make the platform 20 and the down tube 50 easier to obtain by a consumer and easier to replace because the down tube 50 and the platform 20 can each be purchased separately by the consumer and assembled by the consumer on-site. Fourth, the retaining features 27 and 57 make the platform 20 and the down tube 50 easier to ship because a pre-assembled or integral blow molded down tube-platform unit is bulky and more prone to damage during transport.

In alternative embodiments, the platform 20 and the down tube 50 are formed from a single molded piece. In such embodiments, there is no need for a down tube retaining feature 27 or a platform retaining feature 57 because the platform 20 and the down tube 50 are already integrally connected. When the platform 20 and the down tube 50 are a single piece, the single piece may be in the form of a tapered cone. A tapered cone shape provides an advantage for packaging and shipping by allowing for multiple pieces to be nested together and therefore packaged efficiently.

The second end 52 of the down tube 50 may be covered by a cap, plug, integral surface, or the like, or may engage another surface. However, this is not necessary, and the second end 52 of the down tube 50 does not need to be capped or plugged. The second end 52 of the down tube 50 can engage an inner surface of the bottom wall 12a of the container 10, as shown in FIGS. 1 and 14. Having the down tube 50 contact the inner surface of the bottom wall 12a has several advantages. First, the down tube 50 can serve as a structural support for the platform 20 as the aperture 25 moves closer to the center of the platform 20. Second, the bottom wall 12a of the container 10 can cover the second end 52 of the down tube 50 to close the second end 52. This may be particularly important because the down tube 50 may be filled with soil that should remain in the down tube 50. Soil may also be added on top of the platform 20, in the second environment 18b. Plants may be put into the soil in the second environment 18b, such that the roots of the plants soak up water that wicks up through the soil in the down tube 50. However, it is not strictly necessary that the second end 52 of the down tube 50 engages the bottom wall 12a of the container 10. It is not necessary that the down tube 50 extends all the way to the bottom wall 12a of the container 10.

Referring now to FIGS. 6, 11, the down tube 50 may further include at least one slit 54 through the wall 53a of the down tube body 53 between the first end 51 and the second end 52. In the embodiment illustrated in FIGS. 6 and 11, the down tube 50 has a plurality of slits 54 spaced along the linear length of the down tube body 53 between the threaded surface of the platform retaining feature 57 at the first end 51 and the second end 52. The slits 54 may be spaced in intervals, such as every one inch of linear length, but are not so limited. The slits 54 may allow water to seep into the down tube 50 where it can be absorbed by the soil that is packed into the down tube 50 and distributed to the roots of any planted matter. Each slit 54 may be any shape or size of opening that is configured to allow passage of a liquid, such as water, therethrough, but also keep soil retained within the down tube 50. The slits 54 are configured to allow water into the down tube 50 from the first environment 18a while keeping soil in the down tube 50 from exiting the down tube 50 into the first environment 18a.

Referring now to FIGS. 1, 8, 12, the self-watering planter 2 may further include a fill tube 60. The fill tube 60 can be made of a variety of materials such as PVC pipe. As best shown in FIGS. 10-12, the fill tube 60 may have a hollow cylindrical body 61 extending between a first end 62 and a second end 63. However, the body 61 does not have to be cylindrical. For example, the fill tube 60 could be conical. Many shapes of the fill tube 60 are possible and encompassed within the scope of the present disclosure. The first end 62 and the second end 63 may be open to permit the passage of fluid through the fill tube 60 from the first end 62 to the second end 63. Thus, the fill tube 60 may be used to insert a fluid such as water, or small solids such as fertilizer, for example a slow release fertilizer, into the first environment 18a.

The fill tube 60 may have a size and shape that allows the fill tube 60 to be inserted into the opening 28 in the platform 20 with some length of the body 61 extending through the platform 20, as shown in FIGS. 10-12. As best illustrated in FIGS. 11-12, the second end 63 of the fill tube 60 may be cut at an angle for reasons that will be explained below. However, it is not necessary that the second end 63 be cut at an angle.

The fill tube 60 may have a protruding rim 64 that extends radially away from the center of the fill tube 60. The protruding rim 64 may be formed integral with the fill tube 60. Or, as illustrated in FIG. 11, the rim 64 may be created by attaching a sleeve 65 around the outer surface of the body 61 of the fill tube 60. As best illustrated in FIG. 12, a surface of the protruding rim 64 may be adapted to engage the first surface 21 of the platform 20 when the fill tube 60 extends through the opening 28 in the platform 20. However, this is not strictly necessary. Additionally, the outer surface of the body 61 of the fill tube 60 may be sized and shaped to frictionally engage the surface of the opening walls 29. In this manner, the fill tube 60 may be positively positioned within the opening 28 in the platform 20 and be supported on the platform 20.

In alternative embodiments, the self-watering planter 2 does not include a fill tube 60. Instead of using a fill tube to add water or fertilizer to the first environment 18a, a user may simply add water to the plant and soil in the second environment 18b and the water may filter through the soil into the first environment 18a through the slits 54 where the water may be stored until wicked up by the soil. In such embodiments, the platform 20 may not include the opening 28. Such embodiments may be particularly useful for smaller sized containers 10, such as for house plants.

The self-watering planter 2 can be easily assembled without the use of tools or glue. If included, the sealing member 40 may be attached to the outer wall 24 of the platform 20 so that the sealing member 40 extends around the perimeter of the platform 20, as shown in FIGS. 11-12. The platform 20 may be packaged and shipped with the sealing member 40 already attached.

The down tube 50 may be attached to the platform 20 by first axially aligning the first end 51 of the down tube 50 with the aperture 25 in the platform 20. Once aligned, the first end 51 of the down tube 50 may be inserted into the aperture 25 such that the platform retaining feature 57 on the down tube 50 engages the down tube retaining feature 27 on the platform 20. The down tube 50 is then rotated relative to the platform 20 to releasably attach the down tube 50 to the platform 20, as shown in FIGS. 10-11. In the embodiment depicted in FIG. 7, the down tube retaining feature 27 and the platform retaining feature 57 can be threaded surfaces such that the down tube 50 is rotated relative to the platform 20 to attach the down tube 50 to the platform 20.

It is advantageous to have the down tube 50 as a separate component from the platform 20. A down tube 50 that is integral with the platform 20 can limit or prevent insertion of the integral structure into certain container designs. A down tube 50 that is separate from the platform 20 is not so limited. In the present disclosure, the down tube 50 may be attached to the platform 20 from inside the cavity 16 in the container 10, which is more accommodating for various container dimensions. Alternatively, the down tube 50 can be attached to the platform 10 outside the container 10 and then the combined structure can be placed into the container 10.

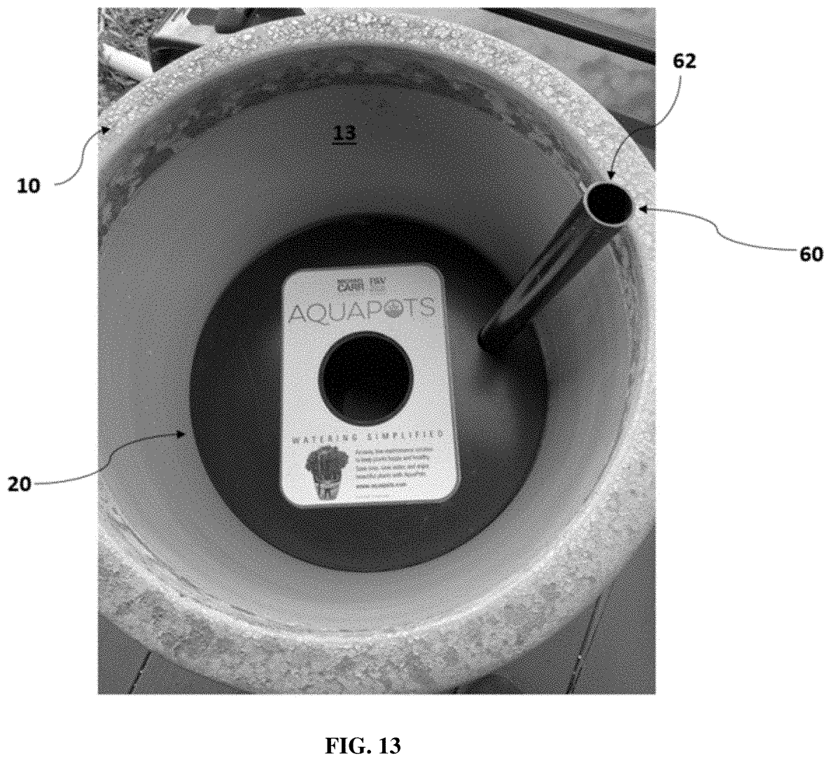

The assembled structure comprising the down tube 50 and the platform 20 may be lowered into the container 10 until the outer walls 24 of the platform 20, or the sealing member 40, if included, frictionally engages the side walls 13 of the container 10, as shown in FIGS. 13-14 (without the sealing member 40), until the second end 52 of the down tube 50 is firmly resting on the inner surface of the bottom wall 12a, as shown in FIG. 14, and/or until the platform 20 is resting on the platform engagement surface 19. In some embodiments, the platform 20 is retained in the container 10 through frictional engagement between the outer walls 24 of the platform 20, or sealing member 40 if included, and the inner surface of the side wall 13 and the platform 20 is also supported by the down tube 50. In other embodiments, the platform 20 engages and rests on the platform engagement surface 19 with the platform engagement surface 19 supporting the weight of the platform 20, as shown in FIG. 13. As best illustrated in FIGS. 1 and 14, the platform 20 may divide the cavity 16 into a first environment 18a, which may contain water, and a second environment 18b, which may contain a growing medium. The platform 20 should be retained in the container 10 at a greater distance from the bottom wall 12a than the hole 17. This ensures that the hole 17 is not unobstructed by the platform 20 so that excess water in the first environment 18a may be drained from the container 10 through the hole 17 in the side wall 13.

The fill tube 60 may be attached to the platform 20 before inserting the platform 20 into the cavity 16 or after inserting the platform 20 into the cavity 16. The second end 63 of the fill tube 60 may be inserted through the opening 28 in the platform 20. As best illustrated in FIGS. 1 and 14, the second end 63 may continue to be extended through the platform 20 into the container 10 until the second end 63 contacts the inner surface of the bottom wall 12a. It may be advantageous to have the second end 63 cut at an angle so that the second end 63 does not sit flush against the inner surface of the bottom wall 12a. This may ensure that the second end 63 is not physically blocked by the inner surface of the bottom wall 12a so that fluid can pass through the fill tube 60 and into the first environment 18a. The fill tube 60 may be inserted through the opening 28 in the platform 20 until a surface of the protruding rim 64, if present, engages the first surface 21 of the platform 20 to restrict further insertion of the fill tube 60 into the container 10.

Referring now to FIG. 14, once the self-watering planter 2 has been assembled to include at least the platform 20 with the down tube 50 and the fill tube 60 attached, the first and second environments 18a and 18b can be developed. Soil 70 can be packed into the down tube 50 and above the first surface 21 of the platform 20 to form a layer of soil 70 in the second environment 18b where plants can be planted, as shown in FIG. 14. Water 71 can be poured through the fill tube 60 into the first environment 18a where the water 71 is stored until taken up by plants planted in the self-watering planter 2, as shown in FIG. 14. The self-watering planter 2 can hold a very large reservoir of water 71 in the first environment 18a. Any excess water 71 is drained out of the first environment 18a through the hole 17 in the side wall 13 of the container 10. The water 71 may seep through the slits 54 in the down tube 50 where the water is absorbed by the soil 70 that is packed into the down tube 50. The soil 70 acts as a wick that distributes the water 71 into the second environment 18b where the water 71 and any nutrients therein (e.g., from fertilizer added to the first environment 18a) can be absorbed by the root base of a plant in the self-watering planter 2.

The size of the down tube 50 can regulate how much water 71 is absorbed and distributed to a plant planted in the self-watering planter 2. In some embodiments, the self-watering planter 2 can last two or more weeks between watering, even in full sun. The self-watering planter 2 provides an incredibly efficient use of water 71, while keeping all of the nutrients in the soil 70 instead of washing them away. Moreover, the self-watering planter 2 can hold a very large reservoir of water in the first environment 18a so that larger-sized self-watering planters 2 can withstand incredible wind forces when full of water 71. The self-watering planter 2 further provides a beneficial environmental impact by eliminating water waste and fertilizer run-off.

Advantageously, the self-watering planter 2 also provides for self-watering capability without the staining typically caused by conventional self-watering pots that have draining holes in the bottom. The self-watering planter 2 is also easy to maintain, where a user may simply refill the second environment 18b with water every one to two weeks or so, depending on factors such as the type and size of plant in the self-watering planter 2 and environmental conditions. Water 71 will come out of the hole 17 when the second environment 18b is sufficiently filled, providing an easy way for a user to know when the self-watering planter 2 is filled. And the self-watering planter 2 is easily assembled and disassembled for cleaning, without the need for any tools or adhesives.

The principle and mode of operation of this disclosure have been explained and illustrated in its various embodiments. However, it must be understood that this disclosure may be practiced otherwise than as specifically explained and illustrated without departing from its spirit or scope.

1. A self-watering planter comprising:
a container comprising a bottom wall and at least one side wall which defines a cavity in the container, wherein the at least one side wall includes a hole therethrough;
a platform having a first surface and a second surface and an outer wall, wherein the platform is adapted to fit in the cavity and thereby separate the cavity into a first environment and a second environment, wherein the platform has an aperture extending through the platform and an opening extending through the platform, and wherein the aperture includes a down tube retaining feature;
a down tube having a body spanning a length between a first end and a second end, wherein the first end includes a platform retaining feature configured to mate with the down tube retaining feature, wherein the down tube further comprises at least one slit along the length of the body; and
a fill tube having a body extending between a fill tube first end and a fill tube second end, wherein the fill tube is configured to extend through the opening in the platform.

2. The self-watering planter defined in claim 1, wherein the down tube retaining feature is a threaded surface and wherein the platform retaining feature is a threaded surface.

3-6. (canceled)

7. The self-watering planter defined in claim 1, wherein the fill tube second end is angled.

8. The self-watering planter defined in claim 1, wherein the fill tube includes a protruding rim configured to engage the first surface of the platform.

9. The self-watering planter defined in claim 8, wherein the protruding rim is formed by a sleeve attached to the body of the fill tube.

10. (canceled)

11. The self-watering planter defined in claim 1, wherein the platform retaining feature of the down tube is mated with the down tube retaining feature of the platform.

12. (canceled)

13. The self-watering planter defined in claim 11, wherein the second end of the down tube contacts the bottom wall of the container.

14. The self-watering planter defined in claim 1, wherein the second end of the fill tube is inserted through the opening in the platform.

15-28. (canceled)

29. The self-watering planter defined in claim 1, wherein the second end of the down tube contacts the bottom wall of the container.

30. The self-watering planter defined in claim 1, wherein the fill tube second end contacts the bottom wall of the container.

31. The self-watering planter defined in claim 30, wherein the fill tube second end is angled.

32-35. (canceled)

36. The self-watering planter defined in claim 1, wherein the container is a pot.

37. The self-watering planter defined in claim 1, further comprising a platform engagement surface extending from the side wall.

38. The self-watering planter defined in claim 37, wherein the platform is inserted into the cavity of the container and the outer wall of the platform engages the platform engagement surface.

39. A self-watering planter comprising:
a container defining a cavity between an open top and a closed bottom, wherein the container comprises a side wall extending from the open top to the closed bottom;
a rim extending around a perimeter of the container in the cavity;
a platform configured to rest on the rim in the container, wherein the platform comprises an aperture extending therethrough with a down tube retaining feature, and an opening extending therethrough;
a down tube comprising a platform retaining feature configured to mate with the down tube retaining feature of the aperture; and
a fill tube configured to extend through the opening.

40. The self-watering planter of claim 39, wherein the down tube comprises at least one slit therethrough.

41. The self-watering planter of claim 39, further comprising a drainage hole in the side wall.

42. The self-watering planter of claim 41, wherein the drainage hole is positioned between the rim and the closed bottom.

43. The self-watering planter of claim 39, wherein the container comprises ceramic.

44. (canceled)

45. A self-watering planter comprising:
a container defining a cavity between an open top and a closed bottom, wherein the container comprises a side wall extending from the open top to the closed bottom; and
a single molded piece defining a platform and a down tube, wherein the platform is configured to rest on a rim in the container and the down tube is configured to extend from the platform, wherein the downtube includes at least one slit configured to allow passage of a liquid through the down tube.

46-52. (canceled)
